(19) United States
(12) Patent Application Publication
(10) Pub. No.: US 2001/0055709 A1
(43) Pub. Date: Dec. 27, 2001

(54) Flow body, process for its production and use of the same

(76) Inventor: Jochen Sang, Kirchheim/Teck (DE)

Correspondence Address: EVENSON, McKEOWN, EDWARDS & LENAHAN, P.L.L.C., Suite 700, 1200 G Street, N.W., Washington, DC, 20005, US

(21) Appl. No.: 09/821,117

(22) Filed: Mar. 30, 2001

(30) Foreign Application Priority Data
Mar. 30, 2000 (DE) 100 15 920.6-51

(51) Int. Cl. H01M 8/04; H01M 8/02

(52) U.S. Cl. 429/34; 429/13; 29/623.4

(57) ABSTRACT

A flow body has a wall and a flow channel inside the wall for a fluid. The flow channel has in an entry region of the fluid into the flow body in the direction of flow, along a central axis, a first region with a convergent cross-sectional profile. Adjoining the first region is a second region with a divergent cross-sectional profile. The flow body is made up along its axis of at least a first segment and a second segment, the first segment having a convergent cross-sectional profile and the second segment having a divergent cross-sectional profile. The segments are connected together at abutting surfaces.

### BACKGROUND AND SUMMARY OF THE INVENTION

This application claims the priority of German Patent Document 100 15 920.6, filed in Germany, Mar. 30, 2000, the disclosure of which is expressly incorporated by reference herein.

The invention relates to a flow body, and to processes for producing and using such a flow body. Preferred embodiments of the invention relate to a flow and the use of a flow body with a wall and a flow channel inside the wall for a fluid, the flow channel having in the entry region of the fluid into the flow body in the direction of flow, along a central axis, a first region with a convergent cross-sectional profile and, adjoining the latter, a second region with a divergent cross-sectional profile.

The production of convergent-divergent nozzles, such as so-called laval or venturi nozzles, usually takes place by machining a blank. Irrespective of the material used, such as metal, ceramic or plastic, the machining of the convergent-divergent flow cross section is very laborious. Nozzles made of metal are usually produced by a metal-removing operation by turning or eroding. Nozzles made of ceramic may be produced by powder injection molding or sintering, nozzles made of plastic may be produced by injection molding. Particularly for ceramic and plastic nozzles, a complex mold is necessary for this operation, in order to produce the undercut through the convergent-divergent bore.

Laval nozzles and laval-like nozzles comprise an axially symmetrical body with a convexly converging nozzle-shaped part and an adjoining concave or conical widening. Flow bodies of this type produce a constant fluid mass flow, as long as the ratio of the pressure in the narrowest part of the nozzle to the pressure upstream of the nozzle does not exceed the value 0.5283 (in the case of diatomic gases). The pressure gain in the widened part of the nozzle makes it possible to keep the amount of fluid constant when there is a constant admission pressure, as long as the ratio of the pressure prevailing at the end of the widening to the admission pressure does not exceed a value of approximately 0.85 to 0.9. The fluid mass flow can thus be manipulated, for example simply via the admission pressure of the nozzle or via the density of the fluid or via a change in the surface area of the narrowest cross section.

German Patent Document DE 196 43 054 A1 (corresponding U.S. Pat. No. 5,967,164) describes a valve with a laval nozzle which is suitable in particular for the metering of a process gas in a reaction process in a fuel cell system.

The invention is based on an object of providing a convergent-divergent flow body of simplified production and use thereof.

This object is achieved according to preferred embodiments of the invention by providing a flow body with a wall and a flow channel inside the wall for a fluid, the flow channel having in the entry region of the fluid into the flow body in the direction of flow, along a central axis, a first region with a convergent cross-sectional profile and, adjoining the latter, a second region with a divergent cross-sectional profile, wherein the flow body is made up along its axis of at least a first segment and a second segment, the first segment having a convergent cross-sectional profile and the second segment having a divergent cross-sectional profile.

This object is also achieved by a process of the flow body in a fuel cell system.

This object of the invention is also achieved by providing a process for producing a flow body with a wall and a flow channel inside the wall for a fluid, a convergent cross-sectional profile and, adjoining the latter, a divergent cross-sectional profile being formed in the flow channel in the entry region of the fluid into the flow body in the direction of flow, along a central axis, characterized in that firstly individual segments are produced, a first segment being produced with a first flow channel portion with a convergent cross-sectional profile inside a wall and a second segment being produced with a second flow channel portion with a divergent cross-sectional profile inside a wall, in that the first segment is made to abut by a first mating surface against a second mating surface of the second segment and is firmly connected, so that the convergent cross-sectional profile merges in the region of the mating surfaces into the divergent cross-sectional profile.

According to the invention, a flow body is made up along its axis of at least two segments, the first segment having a convergent cross-sectional profile and the second segment having a divergent cross-sectional profile.

A particular advantage of the invention is that, in the production of the very complex nozzle form, no molds are necessary any longer to produce undercuts in the nozzle body. The production of such nozzles is consequently made considerably more simple and inexpensive.

Further advantages and refinements of the invention emerge from the further claims and the description.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a basic representation of a flow body constructed according to preferred embodiments of the invention; and

FIG. 2 shows a basic representation of the segments of a preferred flow body constructed according to preferred embodiments of the invention.

### DETAILED DESCRIPTION OF THE DRAWINGS

The invention is suitable in particular for the production of laval nozzles or venturi-like nozzles. Such nozzles are used with particular preference in fuel cell systems.

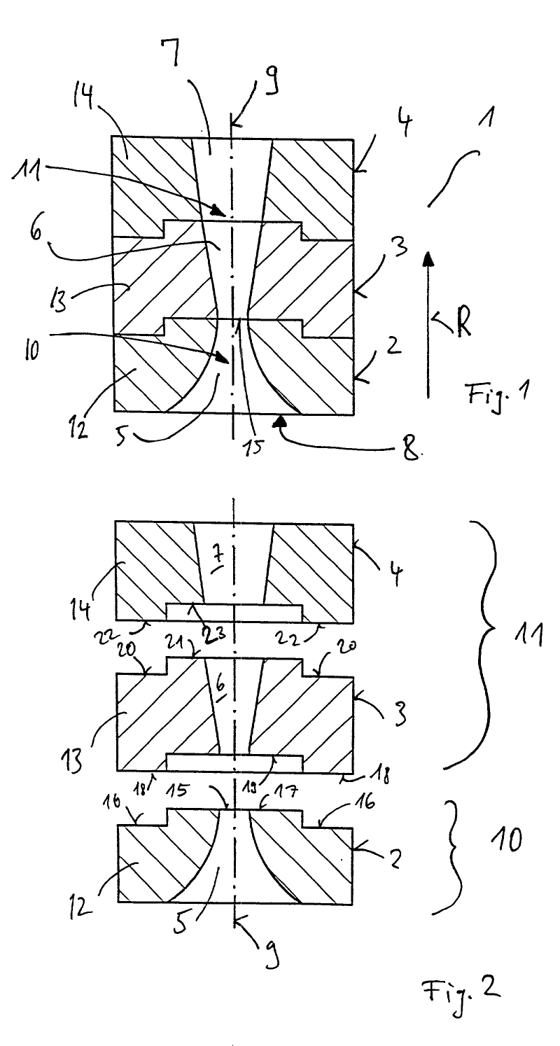

A preferred flow body is represented in FIG. 1. A flow body 1 has a wall 2, 3, 4 and a flow channel 5, 6, 7 inside the wall 2, 3, 4 for a fluid. In the entry region 8 of the fluid into the flow body 1 in the direction of flow R, along a central axis 9, the flow channel 5, 6, 7 has a first region 10 with a convergent cross-sectional profile, i.e. the cross section becomes steadily smaller in the direction of flow. Adjoining this there is a second region 11, with a divergent cross-sectional profile, i.e. the cross section becomes greater in the direction of flow R.

The flow body 1 is made up along its axis 9 of at least a first segment 12 and a second segment 13, the cross section of the first segment 12 having a convergent profile and the cross section of the second segment 13 having a divergent profile. The transition from the convergent region to the divergent region of the flow channel lies exactly at the point of contact where the first segment 12 abuts the second segment 13.

The second segment may be adjoined by a third segment 14, the cross-sectional profile of which is divergent, as in the case of the second segment 13.

Segments of a preferred flow body are represented in FIG. 2. The flow body 1 is made up of three segments 12, 13, 14. The first segment 12 has a convergent cross-sectional profile in the flow channel portion 5, the second segment 13 and a third segment 14 may be joined together in the direction of flow, the two segments 13, 14 forming the second region 11 of the flow body 1 with a divergent cross-sectional profile.

A flow body 1 according to the invention, with a wall 2, 3, 4 and a flow channel 5, 6, 7 inside the wall 2, 3, 4 for a fluid is produced by firstly producing individual segments 12, 13, 14. The segments may be produced as simple turned parts, injection-molded parts or the like.

The first segment 12 is produced with a convergent cross-sectional profile in the flow channel portion 5. A second segment 13 and/or further segments 14 are produced with a flow channel portion 6 with a divergent cross-sectional profile. Subsequently, the segments are brought together with their mating surfaces and firmly connected to one another. Two segments 12, 13 or 13, 14 to be respectively connected are provided for this purpose with mating surfaces, which are designed such that they engage in each other on contact. This allows the segments to be centered in a simple way.

The first segment 12 is provided on its surface opposite the entry opening 8 with a first mating surface 16, 17. In the case of a turned part, this can take place very easily, for instance by machining away a shoulder 16 on this surface and leaving an elevation 17 in the middle. The second segment 13 is given a second mating surface 18, 19, which interacts correspondingly with the first mating surface 16, 17. A depression 19 is provided for the elevation 17 and a rim 18 is provided for the shoulder 16 on the surface of the second segment 13. The two segments 12, 13 are then brought together with their mating surfaces 16, 17, 18, 19 and firmly connected, preferably welded and/or pressed and/or adhesively bonded. In this operation, the convergent cross-sectional profile in the region of the mating surfaces 16, 17, 18, 19 favorably merges at the point of contact into the divergent cross-sectional profile.

The mating surfaces 16, 17, 18, 19 may also be designed as a mirror image of the mating surfaces represented in FIG. 2.

It is favorable to form the region 11 with a divergent cross-sectional profile from at least two segments 13, 14, the second segment 13 being made to abut by a third mating surface 20, 21 with a fourth mating surface 22, 23 of the third segment 14 and firmly connected to it.

The third mating surface 20, 21 interacts with the fourth mating surface 22, 23 in the same way as the mating surfaces 16, 17, 18, 19 of the first segment 12 and of the second segment 13. The advantage is that the inner surfaces of the flow channel portions 6, 7 are easier to produce.

No undercuts occur in the production of the individual segments. This makes the production of such convergent-divergent flow bodies 1 more simple and inexpensive. Although the joining together along the inner surface may cause irregularities to form, which may influence a flow along the inner surface, it is surprisingly found that the irregularities formed by the contact surfaces of the nozzle segments scarcely reduce the efficiency of the nozzle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. Flow body with a wall and a flow channel inside the wall for a fluid, the flow channel having in the entry region of the fluid into the flow body in the direction of flow, along a central axis, a first region with a convergent cross-sectional profile and, adjoining the latter, a second region with a divergent cross-sectional profile,
wherein the flow body is made up along its axis of at least a first segment and a second segment, the first segment having a convergent cross-sectional profile and the second segment having a divergent cross-sectional profile.

2. Flow body according to claim 1, wherein the first and second segments abut each other at a transition from the convergent cross-sectional profile to the divergent cross-sectional profile.

3. Flow body according to claim 1, wherein the second segment is combined with a third segment in the direction of flow to form the second region of the flow body with a divergent cross-sectional profile.

4. Flow body according to claim 1, wherein the flow body is part of a fuel cell system.

5. Process for producing a flow body with a wall and a flow channel along a central axis inside the wall for a fluid, said flow channel having a convergent cross-sectional profile in an entry region of fluid into the flow body in the direction of flow, and a divergent cross-sectional profile adjoining the convergent cross-sectional profile, said process comprising:
producing a first segment with a first flow channel portion with a convergent cross-sectional profile inside a wall,
producing a second segment with a second flow channel portion with a divergent cross-sectional profile inside the wall,
abutting the first segment with a first mating surface against a second mating surface of the second segment, and
firmly connecting the segments along the mating surface so that the convergent cross-sectional profile merges in the region of the mating surfaces into the divergent cross-sectional profile.

6. Process according to claim 5, wherein the first mating surface and the second mating surface are designed such that they engage in each other, at least in certain regions.

7. Process according to claim 5, wherein the region with the divergent cross-sectional profile is formed by at least two segments, the second segment being made to abut by a third mating surface with a fourth mating surface of a third segment, and
wherein said second and third segment are firmly connected together at the third and fourth mating surfaces.

8. Process according to claim 7, wherein the third mating surface and the fourth mating surface are designed in such a way that they engage axially in each other, at least in certain regions.

9. Metering of a process gas in a fuel cell system using a flow body with a wall and a flow channel inside the wall for a fluid, the flow channel having in the entry region of the fluid into the flow body in the direction of flow, along a central axis, a first region with a convergent cross-sectional profile and, adjoining the latter, a second region with a divergent cross-sectional profile,
wherein the flow body is made up along its axis of at least a first segment and a second segment, the first segment having a convergent cross-sectional profile and the second segment having a divergent cross-sectional profile.

10. A method of making a flow body having a flow channel with a divergent section adjoining a convergent section, comprising:
making a first flow body segment with a convergent flow channel section,
making a second flow body segment with a divergent flow channel section, and
joining said first and second flow body segments at abutting surfaces thereof disposed at a transition between the divergent and convergent sections.

11. A method of making a flow body according to claim 10, wherein said flow channel sections are coaxial.

12. A method of making a flow body according to claim 11, wherein said flow channel sections form a laval nozzle.

13. A method of making a flow body according to claim 10, comprising:
forming a third flow body segment with a divergent flow channel section, and
joining said third flow body segment to said second flow body section segment at abutting surfaces thereof to form a continuation of said divergent sections.

14. A method of making a flow body according to claim 10, wherein said making a first flow body segment includes machining surfaces which are to be joined with said second flow body segment.

15. A method of making a flow body according to claim 10, wherein said joining includes welding the abutting surfaces.

16. A method of making a flow body according to claim 10, wherein said joining includes adhesively bonding the abutting surfaces.

17. A method of making a flow body according to claim 10, wherein said flow body segments are formed by injection molding of plastic.

18. A method of making a flow body according to claim 10, wherein said flow body segments are formed by powder injection molding or sintering of ceramic material.

19. A laval nozzle for metering process gas in a reaction process of a fuel cell system comprising:
a first flow body segment with a convergent flow channel section, and
a second flow body segment with a divergent flow channel section adjoining said first flow body segment at facing abutting surfaces thereof at a transition region between coaxial convergent and divergent flow channel sections, whereby said flow body segments can be formed separately from one another without requiring converging and diverging flow channel sections in a single flow body segment.

20. A laval nozzle according to claim 19, wherein said flow body segments are formed by injection molding of plastic.

21. A laval nozzle according to claim 19, wherein said flow body segments are formed by powder injection molding or sintering of ceramic material.
